(19) United States
(12) Patent Application Publication
(10) Pub. No.: US 2006/0069583 A1
(43) Pub. Date: Mar. 30, 2006

(54) Fundraising system and method thereof

(76) Inventor: William H. Owens JR., Nashville, TN (US)

Correspondence Address: FROST BROWN TODD, LLC, 2200 PNC CENTER, 201 E. FIFTH STREET, CINCINNATI, OH, 45202, US

(21) Appl. No.: 10/955,317

(22) Filed: Sep. 30, 2004

(51) Int. Cl. G06Q 99/00

(52) U.S. Cl. 705/1

(57) ABSTRACT

A method for raising funds. A source prints brochures identifying items available for purchase, where at least one of the items are transferable gift certificates having a monetary value and are redeemable for classes of products offered for sale by the source. The source delivers the brochures to a youth organization. Using the brochures, the youth organization solicits customers to place orders for items. The youth organization receives orders and payments for items from customers. The source then receives the orders and payments from the youth organization and then delivers the ordered items, including gift certificates, to the youth organization. The youth organization delivers the items, including gift certificates, to the customers. The customers, or other holders, may order products from the source and use the gift certificates as at least partial payment therefor. The source then delivers the ordered products.

### BACKGROUND

Fundraising programs have become increasingly sophisticated in order to attract participation, from both customers and organizations seeking to raise funds, as well as, maximize the amount of funds raised for organizations seeking to raise funds. These programs continue to grow with technology and offer more and more options to both customers and organizations seeking to raise funds.

### BRIEF DESCRIPTION OF DRAWINGS

While the specification concludes with claims which particularly point out and distinctly claim the invention, it is believed the present invention will be better understood from the following accompanying drawings, in which:

FIG. 1 is a schematic representation of an example of raising funds for a youth organization.

FIG. 2 is a schematic representation of an example of raising funds for a youth organization.

FIG. 3 is a schematic representation of an example of raising funds for a youth organization.

FIG. 4 is a schematic representation of an example of raising funds for a youth organization.

### DETAILED DESCRIPTION

The following description of certain examples of the invention should not be used to limit the scope of the present invention. Other examples, features, aspects, embodiments and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the description and drawings should be regarded as illustrative in nature and not restrictive.

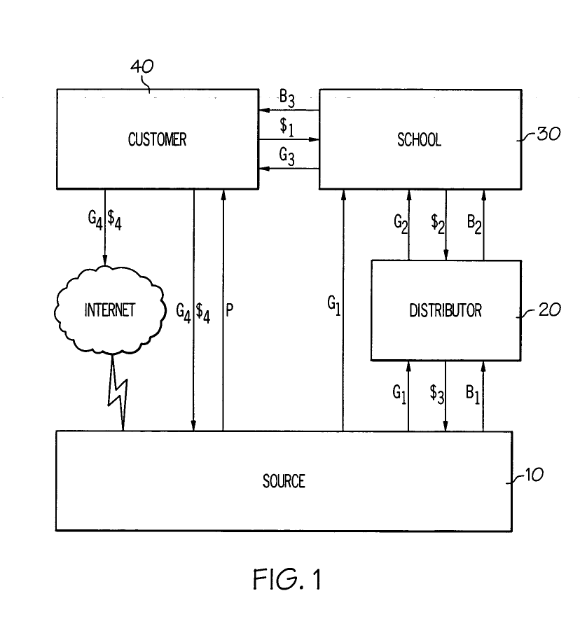

Referring now to the figures, FIG. 1 through FIG. 4 show schematics of exemplary embodiments of methods for raising funds for a youth organization; while the embodiments show the youth organization as being a School, the methods are also applicable to raising funds for other youth organizations, such as clubs, athletic teams, academic teams, religious groups and the like. For the purposes of this description, references to schools, students, faculty members, and administrators should be understood as an exemplary youth organization and should not be understood to be limiting in any way.

Referring now to FIG. 1, a Source 10 prints brochures. The brochures identify gift certificates as an item available for purchase. The gift certificates are identified as having a monetary value associated thereto and as being redeemable for a plurality of products by the purchaser, or other holder, of a gift certificate. The gift certificates may be identified as each having a singular preset monetary value (e.g. each worth $20). Alternatively, the gift certificates may be identified as having several classes of preset monetary values to choose from (e.g. $5 gift certificates, $10 gift certificates, $20 gift certificates, etc.). In yet another alternative, the gift certificates may be identified as having any monetary value selected and paid for by a purchaser. The brochures may also include other items available for purchase such as gift wrap, greeting cards, holiday ornaments, food goods, candles, pens, jewelry, key chains, photo frames, coupon books, magazine subscriptions, books, decorations, floral bulbs, compact discs, video tapes, DVDs, stationary, kitchenware, glassware, gift bags, gift bows and the like.

The Source 10 delivers the brochures B₁ to a Distributor 20. The Distributor 20 may be a division of the Source 10, an employee of the Source 10, a commissioned sales representative, a party under contract with the Source 10, or the like. The Distributor 20 delivers the brochures B₂ to the School 30. Using the brochures B₃, the School 30, through the students, faculty members, and/or administrators, solicits potential customers to place orders for items, including gift certificates, identified in the brochures.

The School 30 receives customer orders and payments $₁ for items, including gift certificates, from Customers 40. The Distributor 20 then receives orders and payments $₂ from the School 30. The Source 10 then receives orders and payments $₃ from the Distributor 20. The Distributor 20 may receive the orders and payments $₂ from the School 30, and the Source 10 may receive the orders and payments $₃ from the Distributor 20, at the end of the School's 30 solicitation efforts or at intervals throughout the School's 30 solicitation efforts. The funds raised by the School 30 and compensation due the Distributor 20 may be collected a variety of ways and may include, without limitation, the following relationships between the various received payments:
$₁>$₂>$₃ (Eq. 1)
$₁>$₂=$₃ (Eq. 2)
$₁=$₂>$₃ (Eq. 3)
$₁=$₂=$₃ (Eq. 4)

In the embodiments illustrated by Eq. 1 and Eq. 2, the customer payments $₁ received by the School 30 from Customers 40 are greater than the received payments $₂ by the Distributor 20 and greater than the received payments $₃ by the Source 10. The difference, $₁-$₂ or $₁-$₃, or a portion of the difference, may constitute all, or part, of the funds raised by the School 30. In the embodiments illustrated by Eq. 3 and Eq. 4, the customer payments $₁ received by the School 30 from Customers 40 are equal to the received payments $₂ by the Distributor 20. The Distributor 20 or Source 10 may then determine and distribute funds raised to the School 30 at a later date, where such determination and distribution may be a lump sum payment based on the number of customer orders, the number of gift certificates redeemed by Customers 40, and the like.

In the embodiments illustrated by Eq. 1 and Eq. 3, the received payments $₂ by the Distributor 20 are greater than the received payments $₃ by the Source 10. The difference, $₂-$₃, or a portion of the difference, may constitute all, or part, of the compensation due the Distributor 20. In the embodiments illustrated by Eq. 2 and Eq. 4, the received payments $₂ by the Distributor 20 are equal to the received payments $₃ by the Source 10. The Source 10 may then determine and distribute compensation due to the Distributor 20 at a later date, where such determination and distribution may be a salary, or wage, based on a pre-existing contractual relationship or may be a lump sum payment based on the number of customer orders, the number of gift certificates redeemed by Customers 40, and the like.

Once the Source 10 has received the orders and payments $₃, the Source 10 delivers the ordered items, including ordered gift certificates G₁, either directly to the School 30 or to the Distributor 20, who then delivers the ordered items, including ordered gift certificates G₂, to the School 30. Optionally, each gift certificate may include unique identification, such as an alphanumeric code, which may have the monetary value of the gift certificate encoded therein. In one embodiment, prior to, or shortly after, delivering the gift certificates G₁, the Source 10 may activate each delivered gift certificate through recordation of each unique identification, thereby allowing each gift certificate to be later redeemed by a Customer 40 or other holder.

The School 30 then delivers the ordered items, including the gift certificates G₃, to the Customers 40. Once the Customers 40 have received the gift certificates, each Customer 40 may use one or more received gift certificates as full or partial payment for products offered for sale by the Source 10, or may transfer one or more of the received gift certificates to one or more holders to be used as full or partial payment for products offered for sale by the Source 10. The products offered for sale by the Source 10 are from a plurality of classes. A class of products is a set, collection, or group of products having certain attributes or traits in common. Some example of classes of products include: gift wrap, greeting cards, holiday ornaments, food goods, candles, pens, jewelry, key chains, photo frames, coupon books, magazine subscriptions, books, decorations, floral bulbs, compact discs, video tapes, DVDs, stationary, kitchenware, glassware, gift bags, gift bows and the like. The products offered for sale may or may not be the same as the items identified in the brochures and may be offered for sale via mail order, the Internet, a telephone operator or recording, and the like. The products may also be offered for sale in a listing of products on a portion of the gift certificate.

The Source 10 receives orders for one or more products selected by a Customer 40 or holder. The order may also include the name of the Customer 40, holder, or other intended recipient, and the appropriate shipping address. The order may also include the unique identifications of one or more gift certificates G₄, where the price of the order is offset by the aggregate monetary value of the one or more gift certificates G₄. In the event that the aggregate monetary value of the one or more gift certificates is not enough to cover the entire price of the products ordered, the Customer 40, or holder, may pay the difference $₄ with cash, check, credit, and the like. The Customer 40, or holder, may place the order for one or more products via the mail, telephone, the Internet and the like.

Once the Source 10 has received an order and full payment for the price of the order, the Source 10 may record the one or more unique identifications of the one or more gift certificates included with the order to deactivate the gift certificates, such that any future transmission of the unique identification of a deactivated gift certificate with an order for products is not accepted and the monetary value of the deactivated gift certificate is not used to offset the price of the order. Alternatively, if the monetary value of a gift certificate exceeds the price of an order, the Source 10 may deduct the price of the order from the monetary value of the gift certificate and record the remaining monetary value of the gift certificate with the unique identification such that the price of any future order including the unique identification of the gift certificate is offset by the remaining monetary value of the gift certificate. The Source 10 then delivers, either itself or through another party such as a distributor, vendor, manufacturer and the like, the one or more products P to the Customer 40, holder, or other intended recipient.

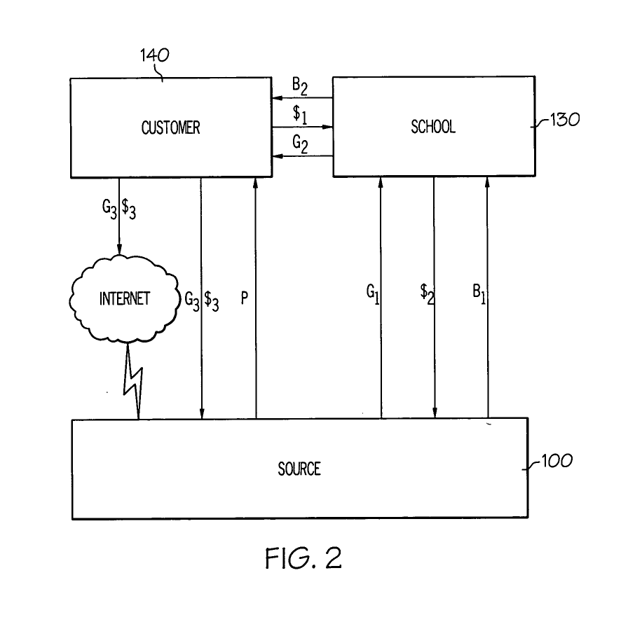

Referring now to FIG. 2 showing another embodiment of a method for raising funds for a youth organization. A Source 100 prints brochures. The brochures identify gift certificates as an item available for purchase. The gift certificates are identified as having a monetary value associated thereto and as being redeemable for a plurality of products by the purchaser, or other holder, of a gift certificate. The brochures may also include other items available for purchase.

The Source 100 delivers the brochures B₁ to the School 130. Using the brochures B₂, the School 130, through the students, faculty members and/or administrators, solicits potential customers to place orders for items, including gift certificates, identified in the brochures. The School 130 receives customer orders and payments $₁ for items, including gift certificates, from Customers 140. The Source 100 then receives orders and payments $₂ from the School 130. The Source 100 may receive the orders and payments $₂ from the School 130 at the end of the School's 130 solicitation efforts or at intervals throughout the School's 130 solicitation efforts. The funds raised by the School 130 may be collected a variety of ways and may include, without limitation, the following relationships between the various received payments:
$₁>$₂ (Eq. 5)
$₁=$₂ (Eq. 6)

In the embodiment illustrated by Eq. 5, the customer payments $₁ received by the School 130 from Customers 140 are greater than the received payments $₂ by the Source 100. The difference, $₁-$₂, or a portion of the difference, may constitute all, or part, of the funds raised by the School 130. In the embodiment illustrated by Eq. 6, the customer payments $₁ received by the School 130 from Customers 140 are equal to the received payments $₂ by the Source 100, where the Source 100 determines and distributes funds raised to the School 130 at a later date, where such determination and distribution may be a lump sum payment based on the number of customer orders, the number of gift certificates redeemed by Customers 140, and the like.

Once the Source 100 has received the orders and payments $₂, the Source 100 delivers the ordered items, including ordered gift certificates G₁ to the School 130. Optionally, each gift certificate may include unique identification, such as an alphanumeric code, which may have the monetary value of the gift certificate encoded therein. In one embodiment, prior to, or shortly after, delivering the gift certificates G₁, the Source 100 may activate each delivered gift certificate through recordation of each unique identification, thereby allowing each gift certificate to be later redeemed by a Customer 140 or other holder.

The School 130 then delivers the ordered items, including the gift certificates G₂, to the Customers 140. Once the Customers 140 have received the gift certificates, each Customer 140 may use one or more received gift certificates as full or partial payment for products from a plurality of classes offered for sale by the Source 100, or may transfer one or more of the received gift certificates to one or more holders to be used as full or partial payment for products from a plurality of classes offered for sale by the Source 100. The products offered for sale may or may not be the same as the items identified in the brochures and may be offered for sale via mail order, the Internet, a telephone operator or recording, and the like. The products may also be offered for sale in a listing of products on a portion of the gift certificate.

The Source 100 receives orders for one or more products selected by a Customer 140 or holder. The order may also include the name of the Customer 140, holder, or other intended recipient, and the appropriate shipping address. The order may also include the unique identifications of one or more gift certificates G₃, where the price of the order is offset by the aggregate monetary value of the one or more gift certificates G₃. In the event that the aggregate monetary value of the one or more gift certificates is not enough to cover the entire price of the products ordered, the Customer 140, or holder, may pay the difference $₃ with cash, check, credit, and the like. The Customer 140, or holder, may place the order for one or more products via the mail, telephone, the Internet and the like.

Once the Source 100 has received an order and full payment for the price of the order, the Source 100 may record the one or more unique identifications of the one or more gift certificates included with the order to deactivate the gift certificates, such that any future transmission of the unique identification of a deactivated gift certificate with an order for products is not accepted and the monetary value of the deactivated gift certificate is not used to offset the price of the order. Alternatively, if the monetary value of a gift certificate exceeds the price of an order, the Source 100 may deduct the price of the order from the monetary value of the gift certificate and record the remaining monetary value of the gift certificate with the unique identification such that the price of any future order including the unique identification of the gift certificate is offset by the remaining monetary value of the gift certificate. The Source 100 then delivers, either itself or through another party such as a distributor, vendor, manufacturer and the like, the one or more products P to the Customer 140, holder, or other intended recipient.

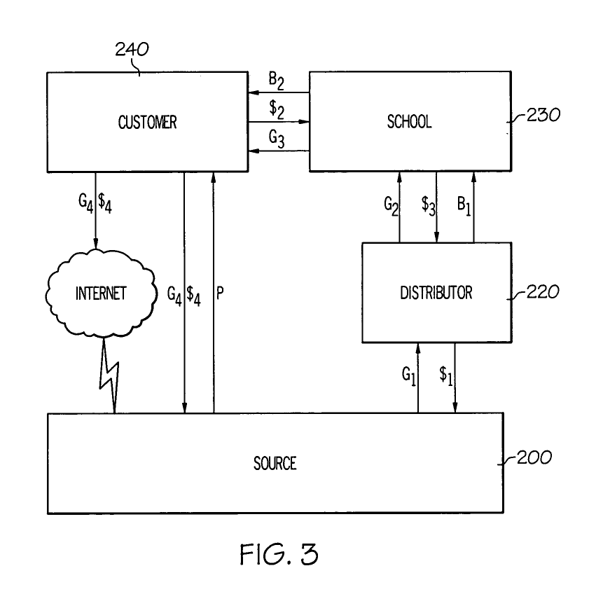

Referring now to FIG. 3 showing another embodiment of a method for raising funds for a youth organization. A Source 200 receives an orders and payment $₁ for gift certificates in bulk from a Distributor 220. The gift certificates have a monetary value associated thereto and are redeemable for a plurality of products by the purchaser, or other holder, of a gift certificate. The Source 220 delivers the gift certificates G₁ to the Distributor 220. The Source 200 may also receive orders for other items and deliver the other items to the Distributor 220.

The Distributor 220 prints brochures. The brochures identify gift certificates as an item available for purchase. The brochures may also include other items available for purchase. The Distributor 220 delivers the brochures B₁ to the School 230. Using the brochures B₂, the School 230, through the students, faculty members, and/or administrators, solicits potential customers to place orders for items, including gift certificates, identified in the brochures.

The School 230 receives customer orders and payments $₂ for items, including gift certificates, from Customers 240. The Distributor 220 then receives orders and payments $₃ from the School 230. The Distributor 220 may receive the orders and payments $₃ from the School 230 at the end of the School's 230 solicitation efforts or at intervals throughout the School's 230 solicitation efforts. The funds raised by the School 230 may be collected a variety of ways and may include, without limitation, the following relationships between the various received payments:
$₂>$₃ (Eq. 7)
$₂=$₃ (Eq. 8)

In the embodiment illustrated by Eq. 7, the customer payments $₂ received by the School 230 from Customers 240 are greater than the received payments $₃ by the Distributor 220. The difference, $₂-$₃, or a portion of the difference, may constitute all, or part, of the funds raised by the School 230. In the embodiment illustrated by Eq. 8, the customer payments $₂ received by the School 230 from Customers 240 are equal to the received payments $₃ by the Distributor 220, where the Distributor 220 determines and distributes funds raised to the School 230 at a later date, where such determination and distribution may be a lump sum payment based on the number of customer orders, the number of gift certificates redeemed by Customers 240, and the like.

Once the Distributor 220 has received the orders and payments $₃, the Distributor 220 delivers the ordered items, including ordered gift certificates G₂, to the School 230. Optionally, each gift certificate may include unique identification, such as an alphanumeric code, which may have the monetary value of the gift certificate encoded therein. In one embodiment, prior to, or shortly after, delivering the gift certificates G₁ to the Distributor 220, the Source 200 may activate each delivered gift certificate through recordation of each unique identification, thereby allowing each gift certificate to be later redeemed by a Customer 240 or other holder. In another embodiment, the Source 200 may receive the unique identification of the gift certificates delivered to the School 230 from the Distributor 220; therewith, the Source 200 activates each gift certificate, thereby allowing each gift certificate to be later redeemed by a Customer 240 or other holder.

The School 230 then delivers the ordered items, including the gift certificates G₃, to the Customers 240. Once the Customers 240 have received the gift certificates, each Customer 240 may use one or more received gift certificates as full or partial payment for products from a plurality of classes offered for sale by the Source 200, or may transfer one or more of the received gift certificates to one or more holders to be used as full or partial payment for products from a plurality of classes offered for sale by the Source 200. The products offered for sale may or may not be the same as the items identified in the brochures and may be offered for sale via mail order, the Internet, a telephone operator or recording, and the like. The products may also be offered for sale in a listing of products on a portion of the gift certificate.

The Source 200 receives orders for one or more products selected by a Customer 240 or holder. The order may also include the name of the Customer 200, holder, or other intended recipient, and the appropriate shipping address. The order may also include the unique identifications of one or more gift certificates G₄, where the price of the order is offset by the aggregate monetary value of the one or more gift certificates G₄. In the event that the aggregate monetary value of the one or more gift certificates is not enough to cover the entire price of the products ordered, the Customer 240, or holder, may pay the difference $₄ with cash, check, credit, and the like. The Customer 240, or holder, may place the order for one or more products via the mail, telephone, the Internet and the like.

Once the Source 200 has received an order and full payment for the price of the order, the Source 200 may record the one or more unique identifications of an order to deactivate the gift certificates, such that any future transmission of the unique identification of a deactivated gift certificate with an order for products is not accepted and the monetary value of the deactivated gift certificate is not used to offset the price of the order. Alternatively, if the monetary value of a gift certificate exceeds the price of an order, the Source 200 may deduct the price of the order from the monetary value of the gift certificate and record the remaining monetary value of the gift certificate with the unique identification such that the price of any future order including the unique identification of the gift certificate is offset by the remaining monetary value of the gift certificate. The Source 200 then delivers, either itself or through another party such as a distributor, vendor, manufacturer and the like, the one or more products P to the Customer 240, holder, or other intended recipient.

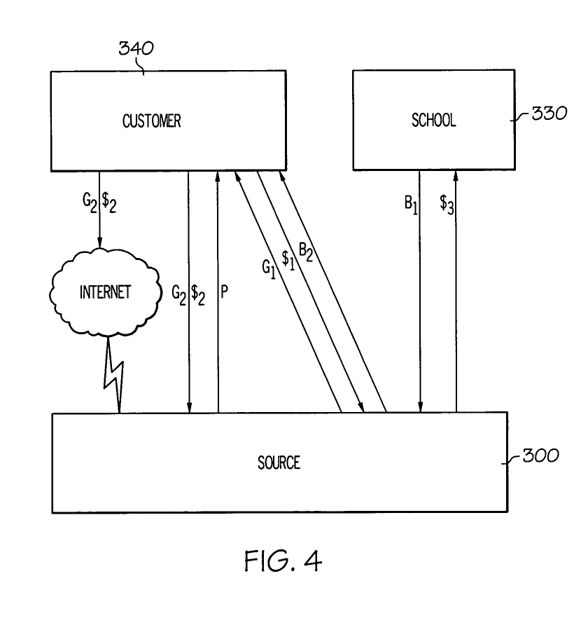

Referring now to FIG. 4 showing yet another embodiment of a method for raising funds for a youth organization. A Source 300 receives a request for brochures B₁ from the School 330. The received request for brochures B₁ may include the names, postal addresses, e-mail addresses, phone numbers, and other identifying information of potential customers identified by the students, faculty members and/or administrators of the School 330. Prior to, or shortly after receiving the request B₁, the Source 300 prints brochures. The brochures identify gift certificates as an item available for purchase. The gift certificates are identified as having a monetary value associated thereto and as being redeemable for a plurality of products by the purchaser, or other holder, of a gift certificate. The brochures may also include other items available for purchase.

The Source 300 solicits the potential customers of the request B₁ to place orders for items, including gift certificates, identified in the brochures by delivering brochures B₂ to the potential customers. The Source 300 then receives customer orders and payments $₁ for items, including gift certificates, from Customers 340.

Once the Source 300 has received the orders and payments $₁, the Source 300 delivers the ordered items, including ordered gift certificates G₁, to the Customers 340. Optionally, each gift certificate may include unique identification, such as an alphanumeric code, which may have the monetary value of the gift certificate encoded therein. In one embodiment, prior to, or shortly after, delivering the gift certificates G₁, the Source 300 may activate each delivered gift certificate through recordation of each unique identification, thereby allowing each gift certificate to be later redeemed by a Customer 340 or other holder.

Once the Customers 340 have received the gift certificates, each Customer 340 may use one or more received gift certificates as full or partial payment for products from a plurality of classes offered for sale by the Source 300, or may transfer one or more of the received gift certificates to one or more holders to be used as full or partial payment for products from a plurality of classes offered for sale by the Source 300. The products offered for sale may or may not be the same as the items identified in the brochures and may be offered for sale via mail order, the Internet, a telephone operator or recording, and the like. The products may also be offered for sale in a listing of products on a portion of the gift certificate.

The Source 300 receives orders for one or more products selected by a Customer 340 or holder. The order may also include the name of the Customer 340, holder, or other intended recipient, and the appropriate shipping address. The order may also include the unique identifications of one or more gift certificates G₂, where the price of the order is offset by the aggregate monetary value of the one or more gift certificates G₂. In the event that the aggregate monetary value of the one or more gift certificates is not enough to cover the entire price of the products ordered, the Customer 340, or holder, may pay the difference $₂ with cash, check, credit, and the like. The Customer 140, or holder, may place the order for one or more products via the mail, telephone, the Internet and the like.

Once the Source 300 has received an order and full payment for the price of the order, the Source 300 may record the one or more unique identifications of the one or more gift certificates included with the order to deactivate the gift certificates, such that any future transmission of the unique identification of a deactivated gift certificate with an order for products is not accepted and the monetary value of the deactivated gift certificate is not used to offset the price of the order. Alternatively, if the monetary value of a gift certificate exceeds the price of an order, the Source 300 may deduct the price of the order from the monetary value of the gift certificate and record the remaining monetary value of the gift certificate with the unique identification such that the price of any future order including the unique identification of the gift certificate is offset by the remaining monetary value of the gift certificate. The Source 300 then delivers, either itself or through another party such as a distributor, vendor, manufacturer and the like, the one or more products P to the Customer 340, holder, or other intended recipient.

The Source 300 dispenses raised funds $₃ to the School 330. The Source 300 may dispense the raised funds $₃ to the School 330 at the end of the School's 330 fundraising program or at intervals throughout the School's 130 fundraising program. The funds raised $₃ may be calculated a variety of ways and may include, without limitation, the following relationship:
$₁>$₃ (Eq. 9)

In the embodiment illustrated by Eq. 9, the customer payments $₁ received by the Source 300 from Customers 340 are greater than the received funds $₃ by the School 330. The difference, $₁-$₃, or a portion of the difference, may constitute all, or part, of the compensation due the Source 300. The Source 300 determines and distributes the raised funds $₃ to the School 330, where such determination and distribution may be a lump sum payment based on the number of customer orders, the number of gift certificates redeemed by Customers 340, and the like

Having shown and described various embodiments, further adaptations of the methods and systems described herein can be accomplished by appropriate modifications by one of ordinary skill in the art without departing from the scope of the present invention. Several of such potential modifications have been mentioned, and others will be apparent to those skilled in the art. While the methods and systems are described in the context of raising funds for a youth organization, the principles may be applied to increasing revenue for any type or organization or cause. Accordingly, the scope of the present invention should be considered in terms of the following claims and is understood not to be limited to the details of structure and operation shown and described in the specification and drawings.

1. A method for raising funds for a youth organization, comprising:
a) printing a plurality of brochures, each brochure identifying a plurality of items to purchase, at least one of said items comprising a gift certificate having an associated monetary value and being redeemable for a plurality of classes of products;
b) delivering said brochures to the youth organization for distribution to customers to solicit placing orders to purchase items identified in the brochure;
c) receiving orders and payments for gift certificates, said received orders and payments corresponding to customer orders and customer payments for the gift certificates, wherein the customer payments are greater than the received payments and the youth organization keeps at least a portion of the difference between the customer payments and the received payments;
d) delivering one or more gift certificates responsive to the received orders;
e) offering for sale products from a plurality of classes;
f) receiving an order for one or more products, the order having a price, said order including a reference to a gift certificate;
g) offsetting the price of the order by the monetary value associated with the referenced gift certificate; and
h) delivering the one or more products corresponding to the order.

2. The method of claim 1, further comprising the step receiving additional payment if the order price exceeds the monetary value associated with the gift certificate.

3-5. (canceled)

6. The method of claim 1, wherein the classes of products comprise three or more classes selected from the group consisting of:
a) gift wrap,
b) greeting cards,
c) holiday ornaments,
d) food goods,
e) candles,
f) pens,
g) jewelry,
h) key chains,
i) photo frames,
j) coupon books,
k) magazine subscriptions,
l) books;
m) decorations;
n) floral bulbs;
o) compact discs;
p) video tapes;
q) DVDs;
r) stationary;
s) kitchenware;
t) glassware;
u) gift bags; and
v) gift bows.

7. The method of claim 1, wherein the gift certificates are transferable.

8. The method of claim 1 wherein each gift certificate further comprises a unique identification.

9. The method of claim 8, further comprising activating the unique identifications associated with delivered gift certificates.

10. The method of claim 9, wherein the reference to a gift certificate in a received order includes the unique identification of the gift certificate.

11. The method of claim 10, further comprising deactivating the unique identification referenced in a received order.

12. The method of claim 8, wherein the unique identification is an alphanumeric code.

13. The method of claim 1, wherein one or more gift certificates are delivered to the youth organization.

14. The method of claim 1, wherein a distributor facilitates at least a portion of the interaction with the youth organization.

15. The method of claim 1 wherein the method is performed sequentially.

16. (canceled)

17. A method for raising funds for a youth organization, comprising:
a) receiving a bulk order and payment for a plurality of gift certificates for distribution by a youth organization to raise funds;
b) delivering a plurality of gift certificates in response to the received order, each gift certificate having an associated monetary value, and being redeemable for a plurality of classes of products;
c) offering for sale products from a plurality of classes;
d) receiving an order for one or more products, the order having a price, said order including a reference to a gift certificate;
e) offsetting the price of the order by the monetary value associated with the referenced gift certificate; and
f) delivering the one or more products corresponding to the order.

18. (canceled)

19. The method of claim 17, wherein each gift certificate further comprises a unique identification.

20. The method of claim 19, wherein the reference to a gift certificate in a received order includes the unique identification of the gift certificate.

21. The method of claim 20, further comprising activating the unique identification associated with delivered gift certificates and deactivating the unique identification referenced in a received order.

22. (canceled)

23. A method for raising funds for a youth organization, comprising:
a) printing a plurality of brochures, each brochure identifying a plurality of items to purchase, at least one of said items comprising a gift certificate having an associated monetary value and being redeemable for a plurality of classes of products;
b) receiving a request for brochures, said received request including identifying information of customers indentified by the youth organization;
c) delivering brochures to the customers;
d) receiving orders and payments for gift certificates from customers;
e) delivering one or more gift certificates responsive to the received orders;
e) offering for sale products from a plurality of classes;
f) receiving an order for one or more products, the order having a price, said order including a reference to a gift certificate;
g) offsetting the price of the order by the monetary value associated with the referenced gift certificate; and
h) delivering the one or more products corresponding to the order.

24. The method of claim 23, wherein each gift certificate further comprises a unique identification.

25. The method of claim 24, wherein the reference to a gift certificate in a received order includes the unique identification of the gift certificate.

26. The method of claim 25, further comprising activating the unique identification associated with delivered gift certificates and deactivating the unique identification referenced in a received order.
